(19) United States
(12) Patent Application Publication
(10) Pub. No.: US 2004/0234709 A1
(43) Pub. Date: Nov. 25, 2004

(54) Ink-jet recording medium for pigment ink and method for production thereof, and recorded matter

(76) Inventors: Tadashi Ishida, Chiba (JP); Masaya Kusumoto, Chiba (JP); Yoshihiko Tomita, Chiba (JP); Sota Ito, Chiba (JP); Hajime Mizutani, Nagano (JP); Hiroyuki Onishi, Nagano (JP); Masaya Shibatani, Nagano (JP)

Correspondence Address: BURNS DOANE SWECKER & MATHIS L L P, POST OFFICE BOX 1404, ALEXANDRIA, VA, 22313-1404, US

(21) Appl. No.: 10/483,968

(22) PCT Filed: Jul. 18, 2002
(86) PCT No.: PCT/JP02/07302

(30) Foreign Application Priority Data
Jul. 18, 2001 (JP) 2001-217554
Feb. 18, 2002 (JP) 2002-40685
Feb. 18, 2002 (JP) 2002-40689

(51) Int. Cl. B41M 5/00

(52) U.S. Cl. 428/32.34

(57) ABSTRACT

An ink jet recording medium for pigment ink, comprising a support and, superimposed thereon, at least one ink receptive layer, characterized in that at least one of the at least one ink receptive layer is a layer composed of particles of a copolymer of 80° C. or higher glass transition temperature prepared from styrene and/or methyl methacrylate (A) and another copolymerizable monomer (B), the particles having a weight average particle diameter of 50 to 500 nm. This ink jet recording medium for pigment ink is excellent in yellowing resistance, ink absorptivity, color density and water resistance and has glossy surface.

### TECHNICAL FIELD

The present invention relates to an ink jet recording medium for pigment ink on which characters and/or images are recorded with a pigment ink, and relates to a process for producing the same. More particularly, the present invention relates to an ink jet recording medium for pigment ink which enables providing a record free from uneven gloss and which can be produced at low cost, and relates to a process for producing the same.

### BACKGROUND ART

The ink jet recording system comprises effecting flight of ink liquid droplets according to various operating principles and sticking them to paper or other recording sheets to thereby attain recording of images, characters, etc. The ink jet recording system is characterized in that not only is realization of high speed, low noise and multicolor easy but also the flexibility of recording pattern is extensive and further in that neither development nor fixation is needed. Therefore, the use of ink jet recording system is rapidly spreading in various fields of application as recording devices for not only Chinese characters but also various graphics, color images, etc. Further, with respect to the images formed by the multicolor ink jet recording system, records that are by no means inferior to multicolor prints through platemaking process and prints through color photography can be obtained as a result of enhancement of resolution and expansion of color reproduction range. In uses in which the number of copies prepared can be small, the application of multicolor ink jet recording system is widening to the field of full color image recording because of the cheapness as compared with photography.

With respect to printers or plotters utilizing the ink jet recording system, efforts are being made to attain an enhancement of resolution and an expansion of color reproduction range in accordance with the market demand for further image quality improvement. These are being coped with by increasing the maximum amount of ink discharged per sheet area. Accordingly, an increase of ink reception capacity in conformity with the amount of ink discharged is now an important technical task for recording sheets, and thus it is now indispensable to ensure high ink reception capacity and attain application of a coating layer capable of desirable color formation. In addition, it is now demanded for appearances, such as gloss, stiffness and hue, to resemble those of sheets for silver salt photography and printing. Meeting these demands with conventional ink jet recording sheets of wood free paper and coated paper is becoming difficult.

The ink absorption capacity is an important property required for recording sheets in conformity with the increase of the amount of discharged ink. For ensuring the ink absorption capacity, it is needed to superimpose a porous coating layer of high void ratio on a support. Accordingly, the method of coating a support with a coating composition comprising a large amount of inorganic particles and a small amount of binder to thereby form an ink receptive layer is generally being attempted. In this method, the amount of binder capable of binding inorganic particles is so small that voids are formed between inorganic particles to thereby ensure an ink absorptivity.

By virtue of the technical progress of recording sheet system, it has become feasible to obtain an image quality comparable to that of photographs. However, as compared with photographs, the recording sheet system has posed problems with light fastness and resistances to gases and yelllowing. These problems involve discoloration upon long-term storage. The light fastness refers to the performance of being free from fading of printed images even when recording sheets are exposed to light. The resistance to gases refers to the performance of being free from fading of printed images even when recording sheets are exposed to gases, such as ozone, NOx and SOx, contained in air. The yellowing resistance refers to the performance of being free from yellowing of recording sheet surface.

In recording sheets, generally, silica and alumina are preferably used as inorganic particles. It is presumed that the surface activity of such inorganic particles is so high that the inorganic particles would exert catalytic action and accelerate the decomposition of ink dye to thereby cause fading of printed images or accelerate the deterioration of cationic polymer in the recording sheet to result in yellowing of the surface of recording sheet.

Furthermore, ink jet recording mediums with surface gloss are increasingly used in particular in order to realize photographic gloss. In such ink jet recording mediums, there is generally employed an arrangement comprising a sheet support of paper, etc. having its one major surface overlaid with an ink receptive layer composed mainly of inorganic fine particles of colloidal silica, vapor-phase process silica, alumina hydrate, γ-type aluminum oxide, etc., known as a void-type ink receptive layer. These ink jet recording mediums are subjected to surface gloss finishing through calendering, etc. in order to realize high surface gloss.

However, when ink jet recording mediums of the above arrangement are calendered at high linear pressure, there has occurred such a problem that voids of the ink receptive layer are damaged so as to result in drop of ink absorption capacity. Often a large amount of ink is impacted on the ink jet recording mediums in order to form color images of high quality. Hence, the drop of ink absorption capacity must be avoided. Consequently, calendering must be performed under such mild conditions that required ink absorption capacity can be ensured. Thus, the current situation is that it is difficult to simultaneously attain ink absorptivity and high gloss.

Ink jet recording medium capable of exhibiting high levels of ink absorptivity and surface gloss to thereby enable outputting of full-color images of high quality and high grade comparable to those of silver salt photographs, which ink jet recording medium can be produced at relatively low cost, is not yet available.

On the other hand, the inks for ink jet recording can largely be classified into dye inks and pigment inks depending on the difference in the type of colorant employed. Dye inks now prevail for the reason of, for example, excelling in color reproduction, solubility in water, etc. However, in recent years, the toughness (light fastness, gas resistance, water resistance, etc.) of recorded images is increasingly emphasized in accordance with the expansion of ink jet recording technology to digital photographic service, commercial printing usage, etc., and pigment inks that are superior to dye inks in image toughness (storability) are also increasingly employed. When the above ink jet recording mediums are printed with the use of pigment ink of these characteristics, obtaining of an ideal record being excellent in not only image quality but also image toughness would be expected.

For example, Japanese Patent Laid-open Publication No. 6(1994)-313141 discloses a water-base ink composition comprising colored emulsion polymerization particles and various water-soluble materials. Japanese Patent Laid-open Publication No. 9(1997)-151342 discloses a recording liquid comprising a microencapsulated pigment composed of an organic pigment coated with an anionic organic polymer compound. Japanese Patent Laid-open Publication No. 10(1998)-95946 discloses a pigment ink wherein polyoxyethylene allylphenyl ether, a polyoxyethylene allylnaphthyl ether compound and an aromatic styrenic acid salt compound are used as pigment dispersants. These pigment inks are excellent in light fastness and water resistance as compared with those of dye inks. However, the yellowing resistance of sheet surface is the inherent problem of recording medium, and cannot be improved by the type of ink employed.

Japanese Patent Laid-open Publication No. 2000-127613 discloses an ink jet recording medium for pigment ink comprising a pigment fixing layer and a solvent absorption layer wherein the solvent absorption layer is constituted of an inorganic porous material while the pigment fixing layer is constituted of alumina hydrate. Japanese Patent Laid-open Publication No. 2000-158803 discloses an ink jet recording sheet for pigment ink comprising a thermoplastic resin layer of 1 μm or greater average particle diameter.

However, the current situation is that the yellowing resistance and glossiness thereof are still unsatisfactory.

Moreover, these conventional ink jet recording mediums for pigment ink have had problems with occurrence of gloss heterogeneity such that there is a gloss difference between printed area and non-printed area and such that on printed area, there is a glossiness difference between regions whose stuck pigment amounts are different from each other.

### PROBLEMS TO BE SOLVED BY THE INVENTION

It is an object of the present invention to provide, for solving the above problems, an ink jet recording medium for pigment ink that exhibits excellent yellowing resistance, ink absorptivity, color density, water resistance and glossiness, being free from gloss heterogeneity after application of pigment inks. It is another object of the present invention to provide a process for producing the ink jet recording medium.

### MEANS FOR SOLVING THE PROBLEMS

The inventors have conducted extensive and intensive studies with a view toward solving the above problems. As a result, it has been found that a recording medium having a layer composed of specified copolymer particles of specified diameter exhibits excellent yellowing resistance, light fastness, ink absorptivity, color density and water resistance and also excels in glossiness as an ink jet recording medium for pigment ink. The present invention has been completed on the basis of this finding. The copolymer particles for use in the present invention, because of slight fusion bonding of particle surfaces, can reconcile interparticulate voids and surface strength, so that not only can the same voids as in the use of inorganic particles according to the prior art be formed thereby but also excellent ink absorptivity can be attained by the use of copolymer particles only without other particles. Further, the copolymer particles do not have high surface activity as exhibited by inorganic particles, so that the use of the copolymer particles leads to excellence in the yellowing resistance of sheet surface.

Specifically, the ink jet recording medium for pigment ink according to the present invention is:

an ink jet recording medium for pigment ink comprising a support and, superimposed thereon, at least one ink receptive layer, characterized in that at least one of the at least one ink receptive layer is a layer composed of particles of a copolymer of 80° C. or higher glass transition temperature prepared from styrene and/or methyl methacrylate (A) and another copolymerizable monomer (B), the-particles having a weight average particle diameter of 50 to 500 nm.

It is preferred that the copolymer particles have a particle diameter distribution, in terms of ratio of weight average particle diameter Dw to number average particle diameter Dn (Dw/Dn), of 1.0 to 2.0.

Preferably, the layer composed of copolymer particles constitutes an outermost surface layer.

Also preferably, two or more ink receptive layers are provided in the ink jet recording medium, and a layer adjacent to the outermost surface layer of the ink receptive layers is a layer composed mainly of porous inorganic particles.

It is preferred that the outermost surface layer be one having been glossed by cast coating or calendering.

One form of ink jet recording medium for pigment ink according to the present invention is:

an ink jet recording medium comprising a support and, superimposed thereon, an ink receptive layer containing inorganic particles,

the ink receptive layer overlaid with a porous ink receptive layer comprising copolymer particles and a cationic coagulant wherein infinitude of copolymer particles are fusion bonded to each other so as to provide interparticulate voids,

the copolymer particles composed of a copolymer of 80° C. or higher glass transition temperature prepared from styrene and/or methyl methacrylate (A) and another monomer copolymerizable with the styrene and/or the methyl methacrylate (B), the particles having a weight average particle diameter of 50 to 500 nm.

Another form of ink jet recording medium for pigment ink according to the present invention is:

an ink jet recording medium for pigment ink, comprising a support and, superimposed on each of both major surfaces thereof, an ink receptive layer containing inorganic particles,

at least one of the ink receptive layers overlaid with a porous ink receptive layer comprising copolymer particles and a cationic coagulant wherein infinitude of copolymer particles are fusion bonded to each other so as to provide interparticulate voids,

the copolymer particles composed of a copolymer of 80° C. or higher glass transition temperature prepared from styrene and/or methyl methacrylate (A) and another monomer copolymerizable with the styrene and/or the methyl methacrylate (B), the particles having a weight average particle diameter of 50 to 500 nm.

In these forms, it is preferred that the copolymer particles be contained in the porous ink receptive layer in an amount of 70 to 99% by weight.

Preferably, the cationic coagulant is a polyamide-polyamine and/or an epichlorhydrin modification product thereof.

Still preferably, the cationic coagulant is contained in the porous ink receptive layer in an amount of 0.01 to 10% by weight.

It is preferred that the porous ink receptive layer be one obtained by coating the ink receptive layer with a coating composition comprising the copolymer particles and the cationic coagulant so as to form a coating layer, drying the coating layer and performing hot calendering thereof.

The process for producing an ink jet recording medium for pigment ink according to the present invention is characterized in that a support or another support furnished with an ink receptive layer on its ink receptive layer side is coated with a coating liquid containing particles of a copolymer of 80° C. or higher glass transition temperature prepared from styrene and/or methyl methacrylate (A) and another copolymerizable monomer (B), the particles having a weight average particle diameter of 50 to 500 nm, and thereafter the coating surface in wet or dry form is pressed against a specular roll so as to smooth the coating surface.

Alternatively, the process for producing an ink jet recording medium for pigment ink according to the present invention is characterized in that it comprises the steps of:

coating a support with a coating composition containing inorganic particles and drying the resultant coating layer to thereby form an ink receptive layer; and

coating the ink receptive layer with a coating composition containing particles of a copolymer of 80° C. or higher glass transition temperature prepared from styrene and/or methyl methacrylate (A) and another copolymerizable monomer (B), the particles having a weight average particle diameter of 50 to 500 nm, and further containing a cationic coagulant so as to form a coating layer and subjecting the coating layer to drying and hot calendering so as to form a porous ink receptive layer.

The record of the present invention comprises the ink jet recording medium for pigment ink defined above having characters and/or images recorded thereon with a pigment ink.

### BRIEF DESCRIPTION OF THE DRAWING

FIG. 1 is a schematic sectional view showing one form of ink jet recording medium for pigment ink according to the present invention.

FIG. 2 is a schematic sectional view showing another form of ink jet recording medium for pigment ink according to the present invention.

FIG. 3 is a schematic sectional view showing a further form of ink jet recording medium for pigment ink according to the present invention.

### BEST MODE FOR CARRYING OUT THE INVENTION

The ink jet recording medium for pigment ink according to the present invention is one comprising a support and, superimposed thereon, at least one ink receptive layer, wherein at least one of the at least one ink receptive layer is a layer composed of particles of a copolymer of 80° C. or higher glass transition temperature prepared from styrene and/or methyl methacrylate (A) and another copolymerizable monomer (B), the particles having a weight average particle diameter of 50 to 500 nm.

This ink jet recording medium will be described in detail below.

### Support

In the present invention, as the support, use can be made of supports conventionally employed in ink jet recording mediums, for example, a paper support such as plain paper, art paper, coated paper, cast coated paper, resin coated paper, resin impregnated paper, noncoated paper or coated paper; a paper support having its both sides or one side coated with polyethylene and/or a polyolefin such as polyethylene having titanium or other white pigment milled therein; a plastic support; and a support of nonwoven fabric, cloth, woven fabric, metal film, metal plate or composite consisting of a laminate of these.

As the plastic support, there can preferably be used, for example, a sheet or film of plastic such as polyethylene, polypropylene, polystyrene, polyethylene terephthalate, polyethylene naphthalate, triacetylcellulose, polyvinyl chloride, polyvinylidene chloride, polyimide, polycarbonate, cellophane or polynylon. Among these plastic supports, transparent, translucent, or opaque ones can appropriately be selected according to intended use.

It is also preferred to use a white plastic film as the support. As the white plastic support, use can be made of a support constituted of a plastic compounded with a small amount of white pigment such as barium sulfate, titanium oxide or zinc oxide, a foamed plastic support provided with translucency by forming a multiplicity of minute voids, or a support furnished with a layer containing a white pigment (e.g., titanium oxide or barium sulfate).

In the present invention, although the configuration of the support is not limited, not only customarily employed films, sheets and plates but also cylindrical form such as that of a drink can, disc form as that of CD or CD-R and other complex forms can be used as the support.

### Ink Receptive Layer

### Copolymer Particle

The copolymer particles for use in at least one of the ink receptive layers are those of a copolymer of 80° C. or higher glass transition temperature obtained by copolymerizing styrene and/or methyl methacrylate (A) with another copolymerizable monomer (B).

The monomer (B) for constituting the copolymer particles can be, for example, any of:

acrylic acid esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate and other C₁-C₁₂ alkyl acrylates;

methacrylic acid esters such as ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate and other C₁-C₁₂ alkyl methacrylates;

unsaturated carboxylic acids such as acrylic acid, methacrylic acid, itaconic acid, maleic acid, fumaric acid, acrylic anhydride, methacrylic anhydride, maleic anhydride, itaconic anhydride and fumaric anhydride;

hydroxylated vinyls such as 2-hydroxyethyl acrylate, 3-hydroxypropyl acrylate, 4-hydroxybutyl acrylate, 2-hydroxyethyl methacrylate, 2-hydroxypropyl methacrylate and 4-hydroxybutyl methacrylate;

aromatic vinyl compounds such as 2-methylstyrene, t-butylstyrene, chlorostyrene, vinylanisole, vinylnaphthalene and divinylbenzene;

unsaturated amides such as acrylamide, methacrylamide, N-isopropylacrylamide, N,N-dimethylacrylamide, N,N-dimethylmethacrylamide, N,N-diethylacrylamide, N,N-diethylmethacrylamide, N-methylolmethacrylamide, N-methylolacrylamide, diacetonacrylamide and maleamide;

aminoalkyl acrylates and aminoalkyl methacrylates and those converted to quaternary salts by a halogenated methyl, a halogenated ethyl, a halogenated benzyl group, etc. such as N,N-dimethylaminoethyl acrylate, N,N-dimethylaminoethyl methacrylate, N,N-dimethylaminopropyl acrylate, N,N-dimethylaminopropyl methacrylate, N,N-t-butylaminoethyl acrylate, N,N-t-butylaminoethyl methacrylate, N,N-monomethylaminoethyl acrylate and N,N-monomethylaminoethyl methacrylate and those converted to quaternary salts by a halogenated methyl, a halogenated ethyl, a halogenated benzyl group, etc.;

N-aminoalkylacrylamides and N-aminoalkylmethacrylamides and those converted to quaternary salts by a halogenated methyl, a halogenated ethyl, a halogenated benzyl group, etc. such as N,N-dimethylaminopropylacrylamide, N,N-dimethylaminopropylmethacrylamide, N,N-dimethylaminoethylacrylamide and N,N-dimethylaminoethylmethacrylamide and those converted to quaternary salts by a halogenated methyl, a halogenated ethyl, a halogenated benzyl group, etc.;

vinyl esters such as vinyl acetate and vinyl propionate;

vinylidene halides such as vinylidene chloride and vinylidene fluoride;

diacrylates such as polyethylene glycol diacrylate, 1,6-hexanediol diacrylate, neopentyl glycol diacrylate, tripropylene glycol diacrylate and polypropylene glycol diacrylate;

dimethacrylates such as ethylene glycol dimethacrylate, diethylene glycol dimethacrylate, triethylene glycol dimethacrylate, polyethylene glycol dimethacrylate, polypropylene glycol dimethacrylate, neopentyl glycol dimethacrylate, 1,3-butylene glycol dimethacrylate, 1,6-hexanediol dimethacrylate and neopentyl glycol dimethacrylate; and

other monomers such as trimethylolpropane trimethacrylate, trimethylolpropane triacrylate, tetramethylolmethane triacrylate, tetramethylolmethane tetraacrylate, allyl methacrylate, dicyclopentenyl acrylate, dicyclopentenyloxyethyl acrylate and the like, and vinyl chloride, vinyl ether, vinyl ketone, vinylamide, chloroprene, ethylene, propylene, isoprene, butadiene, vinylpyrrolidone, 2-methoxyethyl acrylate, 2-ethoxyethyl acrylate, glycidyl acrylate, glycidyl methacrylate, allyl glycidyl ether, acrylonitrile, methacrylonitrile, isopropenyl-αα-dimethylbenzyl isocyanate, allylmercaptan and the like.

These other monomers may be used alone or in combination. As especially preferred monomers among these, there can be mentioned alkyl or hydroxyalkyl esters of acrylic or methacrylic acid, such as methyl acrylate, ethyl acrylate, n-butyl acrylate, isobutyl acrylate, 2-ethylhexyl acrylate, ethyl. methacrylate, n-butyl methacrylate, isobutyl methacrylate, 2-ethylhexyl methacrylate, 2-hydroxyethyl acrylate and 2-hydroxyethyl methacrylate.

With respect to the copolymer for use in the present invention, the glass transition temperature thereof is 80° C. or higher, preferably in the range of 90 to 300° C. and still preferably in the range of 90 to 200° C. When the glass transition temperature is lower than these temperatures, the deformation of copolymer particles in the ink receptive layers may become marked so as to reduce minute interparticulate voids, resulting in a decrease of ink absorptivity. Further, when the glass transition temperature of copolymer particles is low, it is needed to dry them at low temperature. Thus, the production efficiency would drop, and glossiness deterioration would result from a lowering of surface smoothness. The glass transition temperature of copolymer, although varied by the type of monomer component (B), can be regulated through the ratio of monomer component (A)/monomer component (B) at copolymerization. In the present invention, the glass transition temperature can be determined from DSC curves in accordance with Japanese Industrial Standard (JIS) K 7121.

The weight average molecular weight of copolymer for use is preferably 10,000 or more, still preferably in the range of 60,000 to 2 million, and even still preferably in the range of 100 thousand to one million. When copolymer particles whose weight average molecular weight is too small are used, the deformation of copolymer particles may be likely to occur to thereby reduce interparticulate voids with the result that the ink absorptivity of recording sheet may be lowered. The copolymer of the above molecular weight can be obtained by appropriately regulating polymerization conditions, for example, the type of initiator and addition amount thereof, the amount of molecular weight modifier added and the polymerization temperature.

The diameter of copolymer particles for use in the present invention is important. With respect to the copolymer particles for use, the weight average particle diameter is in the range of 50 to 500 nm, preferably 50 to 400 nm, and still preferably 50 to 300 nm. When copolymer particles whose average particle diameter is less than 50 nm are used, there would occur such a problem that insufficiency of interparticulate voids leads to unsatisfactory pigment ink absorptivity to thereby deteriorate the dryability and image quality. On the other hand, when the average particle diameter exceeds the above range, pigment particles of the pigment ink may fall in interstices of copolymer particles with the result that the color density may be lowered and that the surface of recording medium may be iridescent because of diffraction phenomenon.

In the use of these copolymer particles, a pigment ink would be absorbed so as to form a layer of pigment on the surface of ink receptive layer, thereby effecting printing.

With respect to the copolymer particles, the particle diameter distribution is also a factor influencing the ink absorptivity. This particle diameter distribution can be expressed in terms of the ratio of weight average particle diameter Dw to number average particle diameter Dn (Dw/Dn).

The particle diameter distribution, in terms of Dw/Dn, of copolymer particles for use in the present invention is preferably in the range of 1.0 to 2.0, still preferably 1.0 to 1.5 and even still preferably 1.0 to 1.3. When all the particles have the same diameter, the ratio Dw/Dn is 1.0. The ratio Dw/Dn is never less than 1.0. Moreover, when the ratio Dw/Dn exceeds 2.0, the co-presence of large particles and small particles is conspicuous and small particles would come into the interstices of large particles. Thus, interparticulate voids may be insufficient to thereby cause the ink absorptivity to be poor.

The particle diameter can be measured by observation through an electron microscope or the light scattering method. For example, in the light scattering method, the measurement can be effected by the use of laser particle diameter analyzing system LPA-3000/3100 (manufactured by Otsuka Electronics Co., Ltd.), laser diffraction type particle size distribution measuring apparatus SALD-2000A (manufactured by Shimadzu Corporation). etc.

### Process For Producing Copolymer Particle

The copolymer particles for use in the present invention can be produced directly by the known emulsion polymerization process, or by finely dispersing a copolymer produced according to another polymerization process in a liquid medium by a mechanical emulsification technique. For example, in the emulsion polymerization process, there can be employed a method wherein monomers are continuously fed and polymerized and a method wherein various monomers are simultaneously charged and polymerized in the presence of a dispersant and an initiator. In the emulsion polymerization process, the polymerization temperature is generally in the range of 30 to 90° C. Thus, substantially a water dispersion of copolymer particles, generally referred to as “emulsion”, can be obtained. The water dispersion of copolymer particles obtained by the emulsion polymerization process is highly stable in the presence of a small amount of dispersant and is excellent in that copolymer particles of extremely small diameter can be easily obtained.

Examples of preferably used dispersants include a cationic surfactant, a nonionic surfactant, an anionic surfactant, a cationic water-soluble polymer, a nonionic water-soluble polymer and an anionic water-soluble polymer. One, or two or more members can be selected from among these. These dispersants will be described in detail below.

As the cationic surfactant, there can be mentioned, for example, lauryltrimethyl ammonium chloride, stearyltrimethylammonium chloride, cetyltrimethylammonium chloride, distearyldimethylammonium chloride, alkylbenzyldimethylammonium chloride, laurylbetaine, stearylbetaine, lauryldimethylamine oxide, laurylcarboxymethylhydroxyethylimidazolinium betaine, coconut amine acetate, stearylamine acetate, alkylamine guanidine polyoxyethanol, alkylpicolinium chloride or the like. One, or two or more members can be selected from among these.

As the nonionic surfactant, there can be mentioned, for example, polyoxyethylene lauryl ether, polyoxyethylene octylphenyl ether, polyoxyethylene oleylphenyl ether, polyoxyethylene nonylphenyl ether, oxyethylene/oxypropylene block copolymer, t-octylphenoxyethylpolyethoxyethanol, nonylphenoxyethylpolyethoxyethanol or the like. One, or two or more members can be selected from among these.

As the anionic surfactant, there can be mentioned, for example, sodium dodecylbenzenesulfonate, sodium lauryl sulfate, sodium alkyl diphenyl ether disulfonate, sodium alkylnaphthalenesulfonate, sodium dialkylsulfosuccinate, sodium stearate, potassium oleate, sodium dioctylsulfosuccinate, sodium polyoxyethylene alkyl ether sulfate, sodium polyoxyethylene alkyl ether sulfate, sodium polyoxyethylene alkylphenyl ether sulfate, sodium dialkylsulfosuccinate, sodium stearate, sodium oleate, sodium t-octylphenoxyethoxypolyethoxyethyl sulfate or the like. One, or two or more members can be selected from among these.

As the cationic water soluble polymer, there can be mentioned, for example, a cationized polyvinyl alcohol, a cationized starch, a cationized polyacrylamide, a cationized polymethacrylamide, polyamidopolyurea, polyethyleneimine, a copolymer of allylamine or its salt, an epichlorohydrin/dialkylamine adduct polymer, a polymer of diallylalkylamine or its salt, a polymer of diallyldialkylammonium salt, a copolymer of diallylamine or its salt and sulfur dioxide, a diallyldialkylammonium salt/sulfur dioxide copolymer, a copolymer of diallyldialkylammonium salt and diallylamine or its salt or a derivative thereof, a diallyldialkylammonium salt/acrylamide copolymer, an amine/carboxylic acid copolymer or a dialkylaminoethyl (meth)acrylate polymer. One, or two or more members can be selected from among these.

As the dialkylaminoethyl (meth)acrylate polymer, there can be mentioned, for example, a homopolymer or copolymer produced from an aminoalkyl acrylate or aminoalkyl methacrylate such as N,N-dimethylaminoethyl acrylate, N,N-dimethylaminoethyl methacrylate, N,N-dimethylaminopropyl acrylate, N, N-dimethylaminopropyl methacrylate, N,N-t-butylaminoethyl acrylate, N,N-t-butylaminoethyl methacrylate, N,N-monomethylaminoethyl acrylate or N,N-monomethylaminoethyl methacrylate; an N-aminoalkylacrylamide or N-aminoalkylmethacrylamide such as N,N-dimethylacrylamide, N,N-dimethylmethacrylamide, N,N-diethylacrylamide, N,N-diethylmethacrylamide, N,N-dimethylaminopropylacrylamide, N,N-dimethylaminopropylmethacrylamide, N,N-dimethylaminoethylacrylamide, N,N-dimethylaminoethylmethacrylamide or N-isopropylacrylamide; and/or a monomer consisting of any of these converted to a quaternary salt with a halogenated methyl, a halogenated ethyl, a halogenated benzyl or the like.

As the nonionic water soluble polymer, there can be mentioned, for example, polyvinyl alcohol or its derivative; a starch derivative such as oxidized starch, etherified starch or phosphated starch;

polyvinylpyrrolidone or a polyvinylpyrrolidone derivative such as polyvinylpyrrolidone obtained by copolymerization with vinyl acetate; a cellulose derivative such as carboxymethylcellulose or hydroxymethylcellulose;

polyacrylamide or its derivative; polymethacrylamide or its derivative; or gelatin, casein or the like. One, or two or more members can be selected from among these.

As the anionic water soluble polymer, there can be mentioned, for example, any of polyalginic acid or its metal salt; carboxymethylcellulose or its metal salt; polyacrylic acid or its metal salt; a partial hydrolyzate of polyacrylamide or its metal salt; a maleic acid copolymer; lignin sulfonic acid or its metal salt or a derivative thereof; an oxy organic acid or its metal salt; an alkylallylsulfonic acid or its metal salt; a polyoxyalkyl allyl ether; a polyol complex; a higher polyhydric alcohol sulfonic acid or its metal salt; and a water soluble protein such as gelatin or glue or its metal salt or a derivative thereof. One, or two or more members can be selected from among these.

The amount of dispersant used, although not particularly limited, is generally in the range of 0.02 to 20% by weight, preferably 0.02 to 10% by weight, and still preferably 0.02 to 5% by weight based on the total weight of monomers copolymerized.

The initiator for use in the copolymerization can be any of common radical initiators, for example, hydrogen peroxide; persulfates such as ammonium persulfate and potassium persulfate; organic peroxides such as cumene hydroperoxide, t-butyl hydroperoxide, benzoyl peroxide, t-butyl peroxy-2-ethylhexanoate, t-butyl peroxybenzoate and lauroyl peroxide; azo compounds such as azobisisobutyronitrile, 2,2′-azobis(2-amidinopropane) dihydrochloride, 2,2′-azobis[2-(N-phenylamidino)propane] dihydrochloride, 2,2′-azobis{2-[N-(4-chlorophenyl) amidino]propane} dihydrochloride, 2,2′-azobis{2-[N-(4-hydroxyphenyl)amidino]propane} dihydrochloride, 2,2′-azobis[2-(N-benzylamidino)propane] dihydrochloride, 2,2′-azobis[2-(N-allylamidino)propane] dihydrochloride, 2,2′-azobis{2-[N-(2-hydroxyethyl) amidino]propane} dihydrochloride, 2,2′-azobis{2-methyl-N-(1,1-bis(hydroxymethyl)-2-hydroxyethyl]propionamido}, 2,2′-azobis(2-methyl-N-[1,1-bis (hydroxymethyl)ethyl]propionamido}, 2,2′-azobis[2-methyl-N-(2-hydroxyethyl)propionamido] and 2,2′-azobis(isobutylamido) dihydrate; and redox initiators consisting of a mixture of any of these, a metal ion, such as iron ion, and a reducing agent, such as sodium sulfoxylate, formaldehyde, sodium pyrosulfite, sodium hydrogen sulfite, L-ascorbic acid or rongalite. One, or two or more members can be selected from among these initiators.

Generally the amount of initiator used is in the range of 0.01 to 20% by weight based on the total weight of monomers copolymerized.

Further, according to necessity, a mercaptan such as t-dodecylmercaptan or n-dodecylmercaptan, an allyl compound such as allylsulfonic acid, methallylsulfonic acid or a sodium salt thereof, or the like can be used as a molecular weight modifier.

Still further, according to necessity, sulfuric acid, hydrochloric acid, nitric acid, sodium hydroxide, potassium hydroxide, magnesium sulfate, potassium sulfate, aluminum sulfate, sodium acetate, magnesium acetate, potassium acetate, ammonia, triethanolamine, diethanolamine, monoethanolamine, etc. can be used as a pH adjuster.

### Constitution of Ink Receptive Layer

The ink jet recording medium for pigment ink according to the present invention comprises the above support and, superimposed on a surface thereof, at least one ink receptive layer comprising the above copolymer particles. This ink receptive layer may be one composed only of copolymer particles, or one composed of copolymer particles loaded with other components such as a binder and inorganic particles.

Generally, the content of copolymer particles based on the above ink receptive layer constituting components is preferably in the range of 20 to 99% by weight, still preferably 50 to 99% by weight and even still preferably 70 to 99% by weight. When the content of copolymer particles is less than 20% by weight, the voids of the ink receptive layer may be reduced to such an extent that the ink absorptivity is poor.

The specified copolymer particles of the present invention can form the same voids as those formed by conventional inorganic particles. In the use of inorganic particles, a binder for coupling particles is indispensable for maintaining the surface strength. However, the binder tends to fill up interparticulate voids to thereby lower the void ratio and deteriorate the ink absorptivity. By contrast, the copolymer particles according to the present invention, because of slight fusion bonding of particle surfaces as different from the inorganic particles, can reconcile interparticulate voids and surface strength. Consequently, the copolymer particles have characteristics markedly differing from those of inorganic particles in that excellent ink absorptivity and surface strength can be maintained even in the sole use of copolymer particles, namely, even when the content of copolymer particles based on the ink receptive layer constituting components is 100% by weight, and further in that in the need to increase the surface strength, the use of binder in low proportion can be effective.

In the production of glossy recording sheets with the use of copolymer particles of the present invention, copolymer particles being present at the surface are partially deformed so as to enhance the smoothness of the surface. Therefore, ink absorptivity and gloss can simultaneously be attained by a single layer or a layer structure of layers fewer than currently without the need to form a multilayer structure obtainable by coating an ink receptive layer with a gloss imparting layer as having been commonly performed. Hence, the copolymer particles have excellent characteristics from the viewpoint of productivity improvement as well.

In order to enhance the surface strength and gloss, not only the copolymer particles but also a binder can be used in the ink receptive layer. As the binder, there can be mentioned polymers having binder function, for example, water soluble polymers or water dispersions of water insoluble polymer. These will be described in detail below.

As the water soluble polymers, there can be mentioned, for example, various cationic, nonionic and anionic water soluble polymers. More specifically, examples of the cationic water soluble polymers include a cationized polyvinyl alcohol, a cationized starch, a cationized polyacrylamide, a cationized polymethacrylamide, polyamidopolyurea, polyethyleneimine, a copolymer of allylamine or its salt, an epichlorohydrin/dialkylamine adduct polymer, a polymer of diallylalkylamine or its salt, a polymer of diallyldialkylammonium salt, a copolymer of diallylamine or its salt and sulfur dioxide, a diallyldialkylammonium salt/sulfur dioxide copolymer, a copolymer of diallyldialkylammonium salt and diallylamine or its salt or a derivative thereof, a polymer of dialkylaminoethyl acrylate quaternary salt, a polymer of dialkylaminoethyl methacrylate quaternary salt, a diallyldialkylammonium salt/acrylamide copolymer and an amine/carboxylic acid copolymer.

Further, examples of the nonionic water soluble polymers include polyvinyl alcohol or its derivative; a starch derivative such as oxidized starch, etherified starch or phosphated starch; polyvinylpyrrolidone or a polyvinylpyrrolidone derivative such as polyvinylpyrrolidone obtained by copolymerization with vinyl acetate; a cellulose derivative such as carboxymethylcellulose or hydroxymethylcellulose; polyacrylamide or its derivative; polymethacrylamide or its derivative; and gelatin, casein or the like.

Still further, examples of the anionic water soluble polymers include polyalginic acid or its metal salt; carboxymethylcellulose or its metal salt; polyacrylic acid or its metal salt; a partial hydrolyzate of polyacrylamide or its metal salt; a maleic acid copolymer; lignin sulfonic acid or its metal salt or a derivative thereof; an oxy organic acid or its metal salt; an alkylallylsulfonic acid or its metal salt; a polyoxyalkyl allyl ether; a polyol complex; a higher polyhydric alcohol sulfonic acid or its metal salt; and a water soluble protein such as gelatin or glue or its metal salt or a derivative thereof.

As the water dispersion of water insoluble polymer, there can be mentioned, for example, a water dispersion of acrylic polymer (homopolymer or copolymer of acrylic ester and/or methacrylic ester), styrene/acrylic polymer (copolymer of styrene and acrylic ester and/or methacrylic ester), MBR polymer (methyl methacrylate/butadiene copolymer), SBR polymer (styrene/butadiene copolymer), urethane polymer, epoxy polymer or EVA polymer (ethylene/vinyl acetate copolymer).

In the use of a binder, a water dispersion of polyvinyl alcohol, cationized polyvinyl alcohol or acrylic polymer (homopolymer or copolymer of acrylic ester and/or methacrylic ester) is preferred from the viewpoint of characteristics of excelling in yellowing resistance. When the water dispersion is used, the polymer as a constituent of the water dispersion is preferably one whose glass transition temperature is 40° C. or below.

With respect to these polymers having binder function, the addition amount thereof is preferably in the range of 0 to 30 parts by weight, still preferably 0 to 15 parts by weight and even still preferably 0 to 10 parts by weight, per 100 parts by weight of copolymer particles, or when inorganic particles are contained, 100 parts by weight of the total of copolymer particles and inorganic particles. When the amount of binder is in excess, the binder may fill up the voids between copolymer particles to thereby deteriorate the ink absorptivity of ink receptive layer.

The copolymer particles of the present invention, even if mixed with substantially no inorganic particles, can realize high ink absorptivity. Consequently, it is not always indispensable to use copolymer particles together with inorganic particles. However, if desired, copolymer particles can be used in combination with inorganic particles. Examples of inorganic particles that can be used in combination with the copolymer particles include those of precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatom earth, calcium silicate, magnesium silicate, synthetic amorphous silica, colloidal silica, alumina, colloidal alumina, pseudo-boehmite, aluminum hydroxide, lithopone, zeolite, magnesium hydroxide and the like. Among these, porous inorganic particles such as silica and alumina are preferred from the viewpoint of attaining a high void ratio to thereby enhance the ink absorptivity of ink receptive layer. In particular, it is preferred to use fine particles having a primary particle diameter of 100 nm or less, especially 5 to 80 nm.

When these inorganic particles are used in combination with the copolymer particles in the ink receptive layer, the amount of inorganic particles is in the range of 1 to 300 parts by weight, preferably 1 to 190 parts by weight, still preferably 1 to 120 parts by weight and even still preferably 1 to 90 parts by weight per 100 parts by weight of copolymer particles. When the content of inorganic particles is in excess, the light fastness and yellowing resistance may be deteriorated.

In addition, the ink receptive layer comprising the above copolymer particles may be loaded with various additives such as an antistatic agent, an antioxidant, a dry paper strength additive, a wet paper strength additive, a waterproofing agent, an antiseptic agent, an ultraviolet absorber, a photostabilizer, a fluorescent brightener, a coloring pigment, a coloring dye, a penetrant, a blowing agent, a mold release agent, a foam inhibitor, a defoaming agent, a fluidity improver, a thickening agent, a pigment dispersant, a cationic fixer, etc.

The ink jet recording medium for pigment ink according to the present invention comprises a support and, superimposed thereon, one or more ink receptive layers, wherein at least one of the ink receptive layers consists of a layer comprising the above copolymer particles. For example, the ink jet recording medium for pigment ink may have such a monolayer structure of ink receptive layer that only one layer comprising the copolymer particles is superimposed on the support. Alternatively, the ink jet recording medium for pigment ink may have such a multilayer structure that the support is overlaid in sequence with an ink receptive layer of other type and the above layer comprising copolymer particles (ink receptive layer), or overlaid in sequence with the above layer comprising copolymer particles and another ink receptive layer. In any case, a preferred form of construction of recording medium according to the present invention is such that the layer comprised of the above copolymer particles is used as the outermost surface layer of ink receptive layers. A still preferred form thereof is such that while the outermost surface layer consists of the layer comprised of the above copolymer particles, the ink receptive layer adjacent to the outermost surface layer consists of a layer composed mainly of porous inorganic particles such as silica and alumina.

Although it is generally preferred that the layer comprised of copolymer particles according to the present invention be superimposed on a sheet support in a basis weight of 1 to 300 g/m², this is not particularly restrictive.

Further, although it is generally preferred that with respect to the layer composed mainly of porous inorganic particles such as silica and alumina, which is suitable as the ink receptive layer adjacent to the outermost surface layer, a binder be used in an approximate amount of 3 to 40 parts by weight, especially 5 to 30 parts by weight, per 100 parts by weight of inorganic particles mentioned above and the basis weight thereof be in the range of 1 to 300 g/m², these are not particularly restrictive.

According to the above preferred form of construction of recording medium, there can be provided, for example, an ink jet recording medium for pigment ink, comprising a support and, superimposed thereon, an ink receptive layer containing inorganic particles,

the ink receptive layer overlaid with a porous ink receptive layer comprising copolymer particles and a cationic coagulant wherein infinitude of copolymer particles are fusion bonded to each other so as to provide interparticulate voids,

the copolymer particles composed of a copolymer of 80° C. or higher glass transition temperature prepared from styrene and/or methyl methacrylate (A) and another monomer copolymerizable with the styrene and/or the methyl methacrylate (B), the particles having a weight average particle diameter of 50 to 500 nm (first embodiment form).

As another embodiment form, there can be provided an ink jet recording medium for pigment ink, comprising a support and, superimposed on each of both major surfaces thereof, an ink receptive layer containing inorganic particles,

at least one of the ink receptive layers overlaid with a porous ink receptive layer comprising copolymer particles and a cationic coagulant wherein infinitude of copolymer particles are fusion bonded to each other so as to provide interparticulate voids,

the copolymer particles composed of a copolymer of 80° C. or higher glass transition temperature prepared from styrene and/or methyl methacrylate (A) and another monomer copolymerizable with the styrene and/or the methyl methacrylate (B), the particles having a weight average particle diameter of 50 to 500 nm (second embodiment form).

The above first embodiment form and second embodiment form will be described below with reference to the appended drawings.

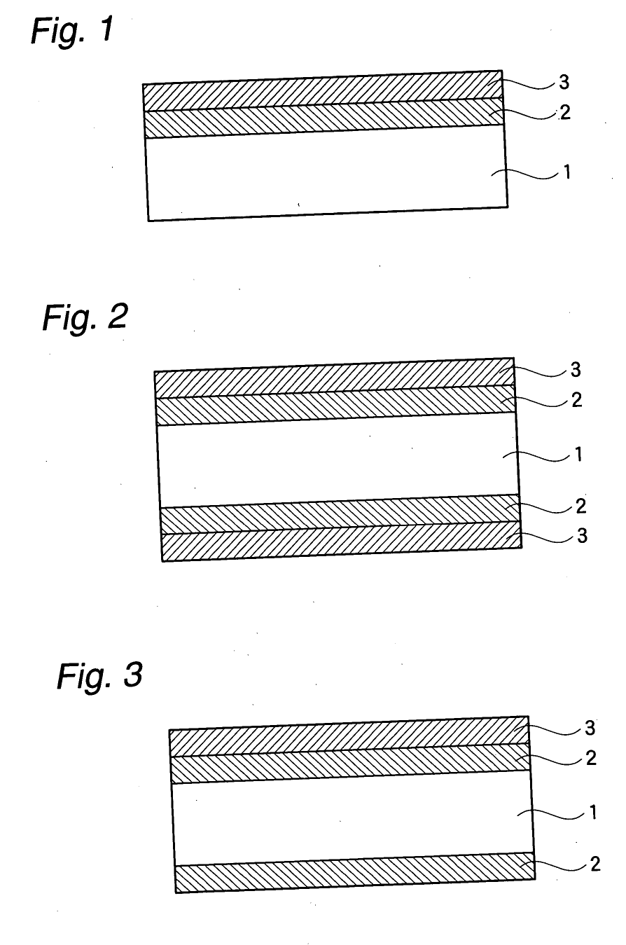

Referring to FIG. 1, the ink jet recording medium according to the first embodiment form comprises a support (1) and, superimposed on one major surface thereof, an ink receptive layer (2) containing inorganic particles, the ink receptive layer (2) overlaid with a porous ink receptive layer (3) comprising copolymer particles and a cationic coagulant wherein infinitude of copolymer particles are fusion bonded to each other so as to provide interparticulate voids.

Referring to FIG. 2, the ink jet recording medium according to the second embodiment form comprises a support (1) and, superimposed on both major surfaces thereof, ink receptive layers (2,2) containing inorganic particles, the ink receptive layers (2,2) respectively overlaid with porous ink receptive layers (3,3) each comprising copolymer particles and a cationic coagulant wherein infinitude of copolymer particles are fusion bonded to each other so as to provide interparticulate voids. The ink jet recording medium for pigment ink according to the second embodiment form is satisfactory as long as at least one of the ink receptive layers (2) is overlaid with the porous ink receptive layer (3). Referring to FIG. 3, only one of the ink receptive layers (2) may be overlaid with the porous ink receptive layer (3). This form of ink jet recording medium can be used in, for example, postcard printing in which the ink receptive layer (2) constituting the undermost layer of FIG. 3 is used for addressing.

The porous ink receptive layer (3) is not limited as long as it comprises the above copolymer particles and cationic coagulant wherein infinitude of copolymer particles are fusion bonded to each other so as to provide interparticulate voids, and the process for producing the same is not limited to the above embodiment.

The thicknesses (dry weight per area) of ink receptive layer (2) constituting the back side and porous ink receptive layer (3) constituting the surface side may be identical with or different from each other.

The support (1) is not particularly limited, and any of those as customarily used as a support in this type of ink jet recording medium can be employed. Examples thereof are as mentioned hereinbefore.

The ink receptive layer (2) is an ink receptive layer containing inorganic particles, generally known as “void type”. As the inorganic particles, use can be made pigments for coating that are commonly employed in the production of coated paper. Examples thereof include silica pigments produced by the precipitation process, gel process, vapor phase process, etc. and further include smectite clay, calcium carbonate, calcium sulfate, barium sulfate, titanium dioxide, kaolin, clay, talc, magnesium silicate, calcium silicate, aluminum oxide, alumina, pseudo-boehmite and the like. These can be used alone or in combination. Among these inorganic particles, silica pigments, especially silica pigments produced by the precipitation process or gel process, are preferred from the viewpoint of ink absorptivity, increase of whiteness and prevention of impurity mixing.

Although the average diameter of such inorganic particles is not limited as long as it is in the range commonly employed in the production of coated paper, it is preferred that the average diameter be in the range of 0.05 to 15 μm, especially 0.1 to 10 μm from the viewpoint that, for example, the smoothness of ink receptive layer and the resolution of image can be enhanced.

From the viewpoint of balance between the color and resolution of recorded images and the storability such as resistance to gases, it is preferred that the specific surface area, as measured by BET, of such inorganic particles be in the range of 100 to 500 m²/g, especially 200 to 400 m²/g.

The content of inorganic particles in the ink receptive layer is preferably in the range of 40 to 90% by weight, still preferably 50 to 80% by weight. When the content is less than 40% by weight, poor ink absorptivity may result. On the other hand, when the content exceeds 90% by weight, the coating film strength of the ink receptive layer may be poor.

Moreover, it is preferred that the ink receptive layer (2) be loaded with a binder resin from the viewpoint of increasing the strength of coating film. As the binder resin, use can be made of any of those commonly employed in this type of ink receptive layer. Examples thereof include polyvinyl alcohol, silanol-modified polyvinyl alcohol, vinyl acetate, starch, carboxymethylcellulose and other cellulose derivatives, casein, gelatin, latexes of conjugated diene copolymers such as styrene-butadiene copolymer, latexes of vinyl copolymers such as ethylene-vinyl acetate copolymer, latexes of acrylic copolymers such as acrylic acid and methacrylic acid copolymers and the like. These can be used alone or in combination. Use of polyvinyl alcohol is especially preferred. Although the amount of binder used can be appropriately regulated, it is preferred that the amount be in the range of 5 to 60% by weight, especially 10 to 50% by weight, based on the total weight of inorganic particles from the viewpoint of balance between the strength of coating film and the ink absorptivity.

According to necessity, the ink receptive layer (2) can be loaded with at least one of various additives usable in this type of ink receptive layer, such as an antistatic agent, a paper strength additive, a waterproofing agent, a dye fixer, a fluorescent brightener, a mildewproofing agent, an antiseptic agent, a surfactant, a thickening agent, a fluidity improver, a pH adjuster, a defoaming agent, a foam inhibitor, a water retention agent, a film hardener, a coloring dye, a coloring pigment, a pigment dispersant, a levelling agent, an ultraviolet absorber, a photostabilizer, a quencher, an antioxidant and the like.

The weight (coating amount), in terms of solid contents, of ink receptive layer (2) is preferably in the range of 10 to 40 g/m², still preferably 20 to 30 g/m².

When the weight is less than 10 g/m², the effect of the ink receptive layer cannot be exerted in ink absorptivity, color forming properties of color materials, etc. On the other hand, when the weight exceeds 40 g/m², the ink receptive layer may suffer powder drop. The thickness of this ink receptive layer per se is preferably in the range of 10 to 40 μm, still preferably 20 to 30 μm.

The porous ink receptive layer (3) according to this embodiment form comprises the above copolymer particles and cationic coagulant wherein infinitude of copolymer particles are fusion bonded to each other so as to provide interparticulate voids. The infinitude of copolymer particles, without completely losing individual shapes, are fusion bonded to each other so as to provide interparticulate voids.

This porous ink receptive layer exhibits excellent surface gloss and ink absorptivity, and ink impacted on the surface thereof can be rapidly penetrated to the above ink receptive layer.

As the copolymer particles, those described hereinbefore can be employed.

In the present invention, the cationic coagulant is incorporated in combination with the copolymer particles. The simultaneous use of cationic coagulant enables avoiding problems, such as intense shrinkage at drying after coating leading to surface cracking, etc., sinking of ink drops or uneven coagulation and difficulty in ensuring dot roundness, as encountered in the use of the composition based on only copolymer particles or based on only copolymer particles mixed with inorganic particles and a binder resin as described later.

As the cationic coagulant, there can be mentioned, for example, low-molecular compounds such as a primary to tertiary amine compound, a primary to tertiary amine salt and a quaternary ammonium salt; and oligomers having a primary to tertiary amino group, a primary to tertiary amine salt group or a quaternary ammonium salt group, or or polymers having such a group. Examples thereof include a polymer of diallyldimethylammonium chloride, a copolymer of epihalohydrin and secondary amine, a copolymer of diallyldimethylammonium chloride and sulfur dioxide, a copolymer of diallyldimethylammonium chloride and acrylamide, a diallylmethylammonium salt polymer, a copolymer of diallylamine hydrochloride and sulfur dioxide, a dimethylmethylamine hydrochloride copolymer, polyallylamine, polyethyleneimine, a polyethyleneimine quaternary ammonium salt compound, a polymer of (meth)acrylamidoalkylammonium salt, an ionene containing quaternary ammonium salt group, a dicyandiamide-formaldehyde polycondensate, a dicyandiamide-diethylenetriamine polycondensate, polyamide-polyamine, a polyamide-polyamine modified with epichlorohydrin and the like. These can be used alone or in combination. Among these, polyamide-polyamine and/or a polyamide-polyamine modified with epichlorohydrin are preferred from the viewpoint of ensuring ink absorption and preventing cracking.

The content of cationic coagulant in the porous ink receptive layer is preferably in the range of 0.01 to 10% by weight, still preferably 0.01 to 5% by weight. When the content is less than 0.01% by weight, the aforementioned effects cannot satisfactorily be attained. On the other hand, when the content exceeds 10% by weight, the viscosity of coating liquid is so high that uniform coating may be disenabled.

The porous ink receptive layer (3), because of being composed mainly of the copolymer particles, exhibits a certain level of coating film strength even when not loaded with any additives. However, from the viewpoint of increasing coating film strength and making assurance doubly sure on the prevention of cracking, the porous ink receptive layer can be loaded with a binder resin. AS the binder resin, use can be made of those as employed in the above ink receptive layer. Use of polyvinyl alcohol or modified polyvinyl alcohol is especially preferred from the viewpoint of preventing discoloration and cracking.

Although the content of binder resin can be appropriately regulated, it is preferred that the content be in the range of 1 to 30% by weight, especially 1 to 15% by weight, based on the total weight of copolymer particles from the viewpoint of balance between coating film strength and ink absorptivity.

Moreover, the porous ink receptive layer (3) can be loaded with inorganic particles in order to further increase the ink absorptivity. As the inorganic particles, use can be made of those as employed in the above ink receptive layer. The content thereof is preferably in the range of 0.1 to 30% by weight, still preferably 0.1 to 20% by weight, based on the total weight of copolymer particles. When the content of inorganic particles exceeds 30% by weight, the light fastness and yellowing resistance (resistance of sheet surface to yellowing by aging) may be deteriorated.

According to necessity, the porous ink receptive layer (3) can be loaded with at least one of the same various additives as employed in the above ink receptive layer (2).

The weight (coating amount), in terms of solid contents, of porous ink receptive layer (3) is preferably in the range of 2 to 50 g/m², still preferably 5 to 30 g/m².

When the weight is less than 2 g/m², satisfactory effects cannot be anticipated. On the other hand, when the weight exceeds 50 g/m², there is the danger of productivity fall.

The thickness of this porous ink receptive layer per se is preferably in the range of 5 to 40 μm, still preferably 5 to 20 μm.

In the porous ink receptive layer (3), the void ratio measured in accordance with J. TAPPI No. 48-85 is preferably in the range of 10 to 90%, still preferably 10 to 70%. When the void ratio is less than 10%, there is the danger of, for example, decrease of ink absorption capacity. On the other hand, when the void ratio exceeds 90%, there is the danger of, for example, detachment of copolymer particles at printing to thereby cause slipping on sheet feed roll, clogging of head, etc. The void ratio is influenced by the type, particle diameter and addition amount of copolymer particles, hot calendering conditions, type and addition amount of cationic coagulant, etc., and hence the void ratio can be adjusted by appropriately regulating these.

### Process For Producing Recording Medium

The recording medium of the present invention can be produced by coating a support or a support overlaid with an ink receptive layer on the ink receptive layer side with a coating composition containing the above copolymer particles and drying the coating composition so as to form a layer. The coating liquid is generally prepared by dispersing copolymer particles obtained by emulsion polymerization together with arbitrarily compoundable other components in water. The coating liquid is preferably one having a solid content of about 5 to 60% by weight.

The method of application of the coating liquid is not particularly limited, and use can be made of, for example, conventional application techniques by means of an air knife coater, a roll coater, a bar coater, a blade coater, a slide hopper coater, a gravure coater, a flexogravure coater, a curtain coater, an extrusion coater, a floating knife coater, a comma coater, a die coater or the like. Application of the coating liquid can be followed by drying of the coating surface.

When it is intended to gloss the coating surface, a specular roll can be pressed onto the coating surface in wet or dry condition after application of the coating liquid to thereby effect treatment for smoothing the coating surface. Common calendering or cast coating technique can be applied. Herein, the calendering refers to the conventional technique wherein with the use of a calender machine such as a supercalender or a gloss calender, the recording medium is passed through gap between rolls having pressure and heat applied thereto so as to smooth the surface of coating layer.

On the other hand, the cast coating technique refers to the method, such as direct method, solidification method, re-wetting method or precasting method, generally used in the production of cast coated paper for printing. The cast coating method comprises holding a coating layer superimposed on a support in wet condition and pressing the coating layer onto a heated specular roll so that the specular surface of the roll is transferred to the coating layer to thereby obtain gloss. Herein, the direct method refers to the method wherein the coating layer in undried condition is pressed onto a heated specular roll to thereby effect drying thereof. The re-wetting method refers to the method wherein the coating layer is dried, re-wetted in a liquid composed mainly of water and pressed onto a heated specular roll to thereby effect drying thereof.

In the calendering or cast coating method, the pressure at press contact, the temperature of specular roll, the coating speed, etc. can be appropriately selected. In particular, it is preferred that the temperature of the specular roll be lower than the glass transition temperature of the copolymer particles. When the temperature of the specular roll is not lower than the glass transition temperature of the copolymer particles, particle deformation may be so extensive as to reduce interparticulate voids, resulting in deterioration of ink absorptivity.

The above recording medium according to the first and second embodiments can be produced by a process comprising the steps of:

coating a support with a coating composition containing inorganic particles and drying the resultant coating layer to thereby form a ink receptive layer; and

coating the ink receptive layer with a coating composition containing copolymer particles and a cationic coagulant so as to form a coating layer and subjecting the coating layer to drying and hot calendering so as to form a porous ink receptive layer.

In the step of forming the ink receptive layer, the above components (inorganic particles, binder resin and other various additives) are dispersed in water to thereby obtain a coating composition for ink receptive layer. The obtained coating composition for ink receptive layer is applied onto the above support in the common manner by means of common coater, such as an air knife coater, a roll coater, a bar coater, a blade coater, a slide hopper coater, a gravure coater, a flexogravure coater, a curtain coater, an extrusion coater, a floating knife coater, a comma coater, a die coater, a gate roll coater, a size press unit or the like, so that the coating amount falls within the aforementioned range, and dried. Thus, the ink receptive layer is formed. According to necessity, for enhancing the surface strength and smoothness, the ink receptive layer may be calendered within such an extent that the ink absorptivity would not deteriorate. The calendering refers to the conventional treatment technique wherein with the use of common calender machine such as a supercalender or a gloss calender, coated paper or the like is passed through gap between rolls having pressure and heat applied thereto so as to smooth the surface thereof.

Thereafter, in the step of forming the porous ink receptive layer, the above components (copolymer particles, cationic coagulant, binder resin, inorganic particles and other various additives) are dispersed in water to thereby obtain a coating composition for porous ink receptive layer. The obtained coating composition for porous ink receptive layer is applied onto the above ink receptive layer in the common manner by means of the above coater so that the coating amount falls within the aforementioned range to thereby form a coating layer, and the coating layer is dried. This drying is performed under such mild conditions that cracking of the coating layer can be avoided. The drying temperature is preferably in the range of 20 to 160° C. As the drying system, use can be made of any of known drying systems, such as the air dryer system, steam cylinder system, heat ray system and microwave system.

After the above drying of the coating layer, the coating layer is hot calendered so as to form the above porous ink receptive layer. The hot calendering can be performed by the use of common calender units, such as a machine calender, a TG calender, a supercalender and a soft calender. It is especially preferred to perform calendering by means of a combination of elastic roll and metal roll, especially the elastic roll being one whose Shore hardness (D) as specified in JIS Z 2246 is in the range of 80 to 95 from the viewpoint that the cracking of coating layer and occurrence of gloss heterogeneity can be inhibited. Although a metal roll of carbon steel material is generally employed, the type of material of the metal roll is not particularly limited. The elastic roll is generally composed of a center portion of iron core and a surface portion of layer of synthetic resin such as urethane, ebonite, nylon or aramid resin.

The heating temperature (temperature of roll surface of calender machine) at the hot calendering is adjusted so that the copolymer particles do not completely melt but are softened to thereby exhibit appropriate adherence. For example, although depending on the glass transition temperature Tg of employed copolymer particles, the heating temperature is preferably in the range of 70 to 160° C., still preferably 80 to 130° C. From the viewpoint of balance between surface gloss and ink absorptivity, it is preferred that the linear pressure at the hot calendering be in the range of 20 to 150 kN/m, especially 50 to 110 kN/m. The calendering speed is preferably in the range of 1 to 500 m/min, still preferably 1 to 300 m/min.

With respect to each of the ink receptive layer and porous ink receptive layer, the given amount may be realized by one coating operation only or by multiple coating operations.

After the completion of the above ink receptive layer forming step and porous ink receptive layer forming step, according to necessity, moisture conditioning by humidification, etc. is carried out to thereby correct curling. As a result, the desired ink jet recording medium for pigment ink can be obtained.

This ink jet recording medium for pigment ink, by virtue of the construction of the ink receptive layer and porous ink receptive layer superimposed thereon, is excellent in ink absorptivity, can ensure dot roundness and can cope with high-speed printing. Further, the ink jet recording medium for pigment ink is excellent in glossiness and is especially suitable for obtaining a record of photographlike high grade and high image quality. Still further, since there is no danger of gloss heterogeneity even if a pigment ink is used, there can be provided an ideal record making full use of the characteristics of pigment ink, namely, a record having high image quality and high image durability comparable to those of silver salt photographs.

Furthermore, since the amount of binder resin, which is generally added to the ink receptive layer in order to increase the coating film strength thereof, added to the porous ink receptive layer can be nil or very small, there is no danger of various adverse effects, such as occurrence of bleeding phenomenon attributed to lowering of ink absorptivity, discoloration or fading of recorded images and yellowing of sheet surface, caused by the binder resin.

Still furthermore, the ink jet recording medium for pigment ink according to the present invention, despite having a surface gloss equivalent or superior to that of cast coated paper (glossy paper produced by the casting process), can be produced at the same production line speed as in the production of common coated paper and hence can be produced with reduced cost as compared with that incurred in the production of conventional highly glossy papers such as cast coated paper. Moreover, generally, coating compositions containing a water absorbent pigment, like the above coating composition for ink receptive layer, have high viscosity, so that the solid content thereof must be usually less than 20% by weight. Consequently, the production of coated paper from such coating compositions is forced to be run at low speed. By contrast, the coating composition for porous ink receptive layer according to the present invention can have its solid content increased to 20% by weight or more, so that the production line speed can be made higher than in the production of coated paper requiring multilayer coating of a coating composition containing water absorbent pigment, thereby enabling reduction of production cost.

The present invention is not limited to the above embodiments, and various modifications can be effected within the realm not departed from the gist. For example, the porous ink receptive layer is not limited as long as it comprises the above copolymer particles and cationic coagulant and infinitude of copolymer particles are fusion bonded to each other so as to provide interparticulate voids, and the method of forming the same is not limited to those of the above embodiments.

### EFFECT OF THE INVENTION

According to the present invention, there can be provided an ink jet recording medium for pigment ink which exhibits excellent yellowing resistance, light fastness, ink absorptivity, color density and water resistance and is glossy, and can be provided a process for producing the recording medium. Although the particular reason for excelling of the present invention in various properties has not yet been elucidated, it can be presumed that ink absorptivity and color density can be reconciled by the use of copolymer particles of specified glass transition temperature and specified particle diameter, and that the organic particles of specified composition do not exhibit high surface activity as exhibited by inorganic particles to thereby realize excellent yellowing resistance.

The ink jet recording medium for pigment ink according to the present invention is excellent in ink absorptivity and glossiness and is free from gloss heterogeneity even if a pigment ink is used. Consequently, there can be provided an ideal record having high image quality and high image durability comparable to those of silver salt photographs. Furthermore, the ink jet recording medium for pigment ink, despite having a surface gloss equivalent or superior to that of cast coated paper, can be produced at the same production line speed as in the production of common coated paper and hence can be produced with reduced cost as compared with that incurred in the production of conventional highly glossy papers.

The ink jet recording medium for pigment ink capable of double-sided printing according to the present invention is excellent in ink absorptivity and glossiness and is free from gloss heterogeneity even if a pigment ink is used. Consequently, there can be provided an ideal double-sided record having high image quality and high image durability comparable to those of silver salt photographs. Furthermore, the ink jet recording medium for pigment ink, despite having a surface gloss equivalent or superior to that of cast coated paper, can be produced at the same production line speed as in the production of common coated paper and hence can be produced with reduced cost as compared with that incurred in the production of conventional highly glossy papers.

### EXAMPLE

The present invention will be further described below with reference to the following Examples, which however in no way limit the scope of the present invention. In the following Examples, the parts and % refer to parts by weight and % by weight, respectively, unless otherwise specified.

### Example

### Copolymer Particle Production Example A-1

144.7 parts of deionized water and 0.05 part of sodium dodecylbenzenesulfonate were charged into a reaction vessel of separable flask provided with reflux condensation capability, and heated to 75° C. in a nitrogen stream. 1.0 part of potassium persulfate was added to the mixture. Separately, 92.0 parts of styrene, 1.0 part of n-butyl acrylate, 2.0 parts of acrylic acid and 5.0 parts of 2-hydroxyethyl methacrylate were emulsified into 40.0 parts of deionized water in the presence of 0.3 part of sodium dodecylbenzenesulfonate to thereby obtain an emulsified mixture. This emulsified mixture was dropped into the above reaction vessel over a period of 4 hr and maintained at the same temperature for 4 hr. Subsequently, the mixture was cooled and neutralized with aqueous ammonia.

As a result, an emulsion composition consisting of particles of a copolymer of styrene, n-butyl acrylate, acrylic acid and 2-hydroxyethyl methacrylate dispersed in water was obtained. The nonvolatile content thereof was 35%, and the pH value of the emulsion composition was 8. The average particle diameter determined by light scattering measurement was 200 nm, and the particle diameter distribution Dw/Dn was 1.12. The glass transition temperature (Tg) of copolymer particles determined from DSC curves in accordance with Japanese Industrial Standard (JIS) K 7121 was 100° C.

### Copolymer Particle Production Example A-2

144.7 parts of deionized water and 0.1 part of stearyltrimethylammonium chloride were charged into a reaction vessel, and heated to 70° C. in a nitrogen stream. 2 parts of 2,2′-azobis(2-amidinopropane) dihydrochloride was added to the mixture. Separately, 92.0 parts of styrene, 1.0 part of n-butyl acrylate, 5.0 parts of 2-hydroxyethyl methacrylate and 2.0 parts of N,N-dimethylaminoethyl acrylate were emulsified into 40.0 parts of deionized water in the presence of 0.3 part of stearyltrimethylammonium chloride to thereby obtain an emulsified mixture. This emulsified mixture was dropped into the above reaction vessel over a period of 4 hr and maintained at the same temperature for 4 hr. Subsequently, the mixture was cooled and neutralized with hydrochloric acid.

As a result, an emulsion composition consisting of particles of a copolymer of styrene, n-butyl acrylate, 2-hydroxyethyl methacrylate and N,N-dimethylaminoethyl acrylate dispersed in water was obtained. The nonvolatile content thereof was 35%, and the pH value of the emulsion composition was 5. The average particle diameter determined by light scattering measurement was 200 nm, and the particle diameter distribution Dw/Dn was 1.04. The glass transition temperature (Tg) of copolymer particles determined from DSC curves in accordance with Japanese Industrial Standard (JIS) K 7121 was 100° C.

### Copolymer Particle Production Example A-3 and Comparative Production Example B-1

Copolymer particles A-3 and copolymer particles B-1 were produced in the same manner as in the Production Example A-1 except that monomer formulations were changed. Summary of the copolymer formulations and properties are listed in Table 1.

### Copolymer Particle Comparative Production Example B-2

37 parts of copolymer particles produced in Production Example A-1 and 594.2 parts of deionized water were charged into a reaction vessel of separable flask provided with reflux condensation capability, and heated to 75° C. in a nitrogen stream. 1.0 part of potassium persulfate was added to the mixture. Separately, 309.7 parts of styrene, 3.4 parts of n-butyl acrylate, 6.7 parts of acrylic acid and 16.8 parts of 2-hydroxyethyl methacrylate were emulsified into 40.0 parts of deionized water in the presence of 0.3 part of sodium dodecylbenzenesulfonate to thereby obtain an emulsified mixture. This emulsified mixture was dropped into the above reaction vessel over a period of 4 hr and maintained at the same temperature for 4 hr. Subsequently, the mixture was cooled and neutralized with aqueous ammonia.

As a result, an emulsion composition consisting of particles of a copolymer of styrene, n-butyl acrylate, acrylic acid and 2-hydroxyethyl methacrylate dispersed in water was obtained. The nonvolatile content thereof was 35%, and the pH value of the emulsion composition was 8. The average particle diameter determined by light scattering measurement was 600 nm, and the particle diameter distribution Dw/Dn was 1.12. The glass transition temperature (Tg) of copolymer particles determined from DSC curves in accordance with Japanese Industrial Standard (JIS) K 7121 was 100° C.

TABLE 1

| | | | | | Comp. | |
|---|---|---|---|---|---|---|
| | | Production Example | | | Prod. Ex. | |
| | | A-1 | A-2 | A-3 | B-1 | B-2 |
| Compsn. | styrene | 92 | 92 | | 76 | 92 |
| | methyl methacrylate | | | 92 | | |
| | butyl acrylate | 1 | 1 | 1 | 17 | 1 |
| | acrylic acid | 2 | | 2 | 2 | 2 |
| | N,N- | | 2 | | | |
| | dimethylaminoethyl | | | | | |
| | acrylate | | | | | |
| | 2-hydroxyethyl | 5 | 5 | 5 | 5 | 5 |
| | methacrylate | | | | | |

| | | | | | |
|---|---|---|---|---|---|
| Ionic property of dispersant | anion | cation | anion | anion | anion |
| Particle diameter (nm) | 200 | 200 | 200 | 200 | 600 |
| Tg(° C.) | 100 | 100 | 100 | 60 | 100 |

### Example 1

An undercoating liquid of 20% solid content was prepared by using 100 parts of amorphous silica as inorganic particles and adding 20 parts of polyvinyl alcohol as a binder, 10 parts of dicyandiamide resin as a cationic resin and 0.5 part of sodium polyphosphate as a dispersant. A base paper of 100 g/m² basis weight was coated with this undercoating liquid using bar and dried so that the coating amount was 8 g/m² on dry basis. Thus, the base paper was overlaid with a recording layer.

On the other hand, a coating composition of 20% solid content was prepared by using 100 parts of copolymer particles obtained in Production Example A-1 and adding 20 parts of polyvinyl alcohol as a binder, followed by uniform agitation. This coating composition was applied onto the above recording layer with the use of wire bar so that the coating amount was 20 g/m² on dry basis. A glossy ink jet recording sheet was obtained by subjecting the resultant coating layer to the cast coating process, specifically pressing the coating layer surface while in wet condition against a specular drum of 95° C. surface temperature at a linear pressure of 100 kg/cm, effecting drying and releasing the coating layer from the specular drum.

### Example 2

A glossy ink jet recording sheet was produced in the same manner as in Example 1 except that in place of the cast coating process, the coating layer surface in dry condition was subjected to calendering, specifically operation of pressing against a specular drum of 95° C. at a linear pressure of 50 kg/cm repeated four times.

### Example 3

A glossy ink jet recording sheet was produced in the same manner as in Example 1 except that the coating composition applied onto the recording layer was loaded with 50 parts of amorphous silica as inorganic particles.

### Example 4

A glossy ink jet recording sheet was produced in the same manner as in Example 1 except that the copolymer particles contained in the coating composition applied onto the recording layer were those produced in Production Example A-2.

### Example 5

A glossy ink jet recording sheet was produced in the same manner as in Example 1 except that the copolymer particles contained in the coating composition applied onto the recording layer were those produced in Production Example A-3.

### Comparative Example 1

An ink jet recording sheet was produced in the same manner as in Example 1 except that as the coating composition applied onto the recording layer, use was made of one composed of 100 parts of amorphous silica and 20 parts of polyvinyl alcohol as a binder.

### Comparative Example 2

A glossy ink jet recording sheet was produced in the same manner as in Example 1 except that the copolymer particles contained in the coating composition applied onto the recording layer were those produced in Production Example B-1.

### Comparative Example 3

An ink jet recording sheet was produced in the same manner as in Comparative Example 2 except that the surface temperature of the specular drum was changed to 60° C.

### Comparative Example 4

A glossy ink jet recording sheet was produced in the same manner as in Example 1 except that the copolymer particles contained in the coating composition applied onto the recording layer were those produced in Production Example B-2.

Summary of the production conditions for these recording sheets are listed in Table 2.

TABLE 2

| | | Copolymer | | |
|---|---|---|---|---|
| | Copolymer | particle/inorg. | Processing | Treatment |
| | particle | particle/binder | system | temp. (° C. ) |
| Example 1 | A-1 | 100/0/20 | cast coating | 100 |
| Example 2 | A-1 | 100/0/20 | calender | 100 |
| Example 3 | A-1 | 100/50/20 | cast coating | 100 |
| Example 4 | A-2 | 100/0/20 | cast coating | 100 |
| Example 5 | A-3 | 100/0/20 | cast coating | 100 |
| Comp. Ex. 1 | | 0/100/20 | cast coating | 100 |
| Comp. Ex. 2 | B-1 | 100/0/20 | cast coating | 100 |
| Comp. Ex. 3 | B-1 | 100/0/20 | cast coating | 60 |
| Comp. Ex. 4 | B-2 | 100/0/20 | cast coating | 100 |

### Method of Evaluation

The quality evaluation of the obtained recording sheets was conducted in the following manner.

### Method Of Measuring Particle Diameter

The average particle diameter and particle diameter distribution (Dw/Dn) were measured by the use of laser particle diameter analyzing system LPA-3000/3100 (manufactured by Otsuka Electronics Co., Ltd.).

### Method Of Measuring Color Density

Solid printing with black ink was effected on each recording sheet by means of commercially available ink jet printer having a pigment ink mounted thereon (model MC2000 manufactured by Seiko Epson Corporation). The optical reflection density of solid part was measured by means of Macbeth densitometer (RD-918).

### Method Of Measuring Image Quality

Lengthwise printing with each of yellow ink, magenta ink, cyan ink and black ink was performed by means of commercially available ink jet printer (model MC2000 manufactured by Seiko Epson Corporation), and the degree of ink flooding and bleeding at printed portion were visually evaluated. The evaluation criteria were as follows:

◯: neither ink flooding nor bleeding and hence excellent;

Δ: ink flooding and bleeding found but on practical level; and

X: ink flooding and bleeding extensive and hence below practical level.

### Method Of Measuring Water Resistance

Character printing with black ink was effected by means of commercially available ink jet printer (model MC2000 manufactured by Seiko Epson Corporation). One drop of city water was placed on printed portion, and allowed to stand still round the clock. Thereafter, the print condition was evaluated by visual inspection. The evaluation criteria were as follows.

◯: There was substantially no bleeding and substantially no change of color density;

Δ: Slight bleeding and deterioration of color density found, but on practicable level; and

X: Bleeding and deterioration of color density found, and hence below practicable level.

### Method Of Measuring Yellowing Resistance

Each recording sheet not subjected to printing was stored in an atmosphere of 80° C. and 50% humidity for one week, and the difference between color before storage and color after storage was measured. The color difference (Δ E) in terms of L*a*b* (expression method according to CIE) was calculated by the formula (ΔE)={(ΔL*)²+(Δa*)²+(Δb* )²}^{½} from the results of measuring of color before light exposure and color after light exposure. The larger the color difference, the more serious the color deterioration.

### Method Of Measuring Gloss

In the gloss measurement, the level of gloss at 75° of the surface of each recording sheet was measured by means of deformation glossmeter (model GM-3D manufactured by Murakami Color Research Laboratory) in accordance with Japanese Industrial Standard (JIS) Z8741.

The evaluation results are listed in Table 3.

TABLE 3

| | | | | | Yellowing |
|---|---|---|---|---|---|
| | Print | Image | Water | White sheet | resistance |
| | density | quality | resistance | gloss (%) | (ΔE) |
| Example 1 | 2.20 | ◯ | ◯ | 85 | 1 |
| Example 2 | 2.15 | ◯ | ◯ | 75 | 1 |
| Example 3 | 2.11 | ◯ | ◯ | 70 | 2 |
| Example 4 | 2.19 | ◯ | ◯ | 83 | 1 |
| Example 5 | 2.18 | ◯ | ◯ | 80 | 1 |
| Comp. Ex. 1 | 1.80 | ◯ | Δ | 15 | 5 |
| Comp. Ex. 2 | 1.76 | X | ◯ | 95 | 1 |
| Comp. Ex. 3 | 1.61 | ◯ | ◯ | 55 | 1 |
| Comp. Ex. 4 | 1.35 | ◯ | ◯ | 73 | 1 |

### Example 1A

### Preparation Of Coating Composition 1A For Porous Ink Receptive Layer

100 parts of copolymer particles A-1 mentioned above, 1 part of cationic coagulant (WS500 produced by Japan PMC) and 7 parts of binder resin (PVA124 produced by Kuraray Co., Ltd.) were added to water and dispersed, thereby obtaining coating composition 1A for porous ink receptive layer whose solid content was 28%.

### Production Of Ink Jet Recording Medium

120 parts of inorganic particles (100 parts of silica gel X37B produced by Tokuyama Corporation plus 20 parts of colloidal silica YL produced by Nissan Chemical Industries, Ltd.) and 20 parts of binder resin (PVA R1130 produced by Kuraray Co., Ltd.) were added to water and dispersed, thereby obtaining a coating composition for ink receptive layer whose solid content was 17%. A support (trade name “SA Kinfuji N”, produced by Oji Paper Co., Ltd., basis weight 157 g/m²) on its one side was coated with this coating composition for ink receptive layer so that the coating amount after drying was 25 g/m², and dried at 120° C. by an air dryer system. Thus, an ink receptive layer was superimposed on the support. Thereafter, the resultant ink receptive layer was coated with the above coating composition 1A for porous ink receptive layer so that the coating amount after drying was 15 g/m², and dried at 90° C. by an air dryer system. Thus, a coating layer was superimposed on the ink receptive layer. Thereafter, the coating layer was subjected to hot calendering by means of calendering machine (“bench calendering machine, single plate type” manufactured by Yuri Roll) performed under such conditions that the heating temperature was 95° C., the linear pressure 100 kN/m and the processing speed 2 m/min, thereby forming a porous ink receptive layer. The thus obtained ink jet recording medium is referred to as sample of Example 1A.

### Example 2A

An ink jet recording medium was produced in the same manner as in Example 1A except that the coating composition 2A for porous ink receptive layer prepared in the following manner was employed in place of the coating composition 1A for porous ink receptive layer. The thus obtained ink jet recording medium is referred to as sample of Example 2A.

### Preparation Of Coating Composition 2A For Porous Ink Receptive Layer

100 parts of copolymer particles A-1 mentioned above, 1 part of cationic coagulant (trade name “Uramine P5600” produced by Mitsui Chemicals, Inc.) and 7 parts of binder resin (trade name “PVA124” produced by Kuraray Co., Ltd.) were added to water and dispersed, thereby obtaining coating composition 2A for porous ink receptive layer whose solid content was 28%.

### Example 3A

An ink jet recording medium was produced in the same manner as in Example 1A except that the coating composition 3A for porous ink receptive layer prepared in the following manner was employed in place of the coating composition 1A for porous ink receptive layer. The thus obtained ink jet recording medium is referred to as sample of Example 3A.

### Preparation Of Coating Composition 3A For Porous Ink Receptive Layer

100 parts of copolymer particles A-1 mentioned above, 1 part of cationic coagulant (trade name “Sumirez Resin 1001”, produced by Sumitomo Chemical Co., Ltd.) and 7 parts of binder resin (trade name “PVA124” produced by Kuraray Co., Ltd.) were added to water and dispersed, thereby obtaining coating composition 3A for porous ink receptive layer whose solid content was 28%.

### Comparative Example 1A

An ink jet recording medium was produced in the same manner as in Example 1A except that any porous ink receptive layer was not provided at all. The thus obtained ink jet recording medium is referred to as sample of Comparative Example 1A.

### Comparative Example 2A

An ink jet recording medium was produced in the same manner as in Example 1A except that the coating composition 4A for porous ink receptive layer prepared in the following manner with the use of copolymer particles B produced according to the following process was employed in place of the coating composition 1A for porous ink receptive layer. The thus obtained ink jet recording medium is referred to as sample of Comparative Example 2A.

### Production Of Copolymer Particles B

10.6 parts of emulsion composition produced in Example 1 (containing 3.7 parts of copolymer particles A-1) and 135.9 parts of deionized water were charged into a reaction vessel of separable flask provided with reflux condensation capability, and heated to 75° C. in a nitrogen stream. 0.5 part of potassium persulfate was added to the mixture. Separately, 72.6 parts of styrene, 17.0 parts of n-butyl acrylate, 4.9 parts of acrylic acid and 1.8 parts of 2-hydroxyethyl methacrylate were emulsified into 40.0 parts of deionized water in the presence of 0.3 part of sodium dodecylbenzenesulfonate to thereby obtain an emulsified mixture. This emulsified mixture was dropped into the reaction vessel over a period of 4 hr and maintained at the same temperature for 4 hr. Subsequently, the mixture was cooled and neutralized with aqueous ammonia.

As a result, an emulsion composition (nonvolatile content 35% and pH 8) consisting of particles B of a copolymer of styrene (monomer A mentioned hereinbefore) and n-butyl acrylate, acrylic acid and 2-hydroxyethyl methacrylate (monomers B mentioned hereinbefore) dispersed in water was obtained. With respect to the copolymer particles B, the glass transition temperature (Tg) was 62° C., the weight average particle diameter 600 nm, and the ratio of Dw/Dn 1.15.

### Preparation Of Coating Composition 4A For Porous Ink Receptive Layer

100 parts of copolymer particles B mentioned above, 1 part of cationic coagulant (WS500 produced by Japan PMC) and 7 parts of binder resin (PVA124 produced by Kuraray Co., Ltd.) were added to water and dispersed, thereby obtaining coating composition 4A for porous ink receptive layer whose solid content was 28%.

### Test Example A

With respect to the obtained ink jet recording mediums and records prepared therefrom in the following manner, the white background glossiness, gloss uniformity, ink absorptivity, dot roundness, water resistance and light fastness were evaluated in the following manner. The evaluation results are listed in Table 4 below.

### Measurement Of White Background Glossiness

With respect to the coating surface of each of the ink jet recording mediums, the 20° specular surface glossiness (according to JIS P8142) was measured by means of deformation glossmeter (model GM-3D manufactured by Murakami Color Research Laboratory). The greater this value, the greater the excellence in glossiness.

### Evaluation Of Floss Uniformity

100% color patches of C, M, Y and Bk four colors were printed on the coating surface of each of the ink jet recording mediums by means of pigment-ink-compliant ink jet printer (trade name “MC2000” manufactured by Seiko Epson Corporation), thereby obtaining records.

With respect to arbitrary 10 points of the printed surface of each of the thus obtained records, the 20° specular surface glossiness of each thereof was measured by means of deformation glossmeter (model GM-3D manufactured by Murakami Color Research Laboratory) Evaluation was conducted from the average and standard deviation of measurements and the above white background glossiness on the following evaluation criteria.

### Evaluation Criteria

A: the difference between glossiness average and white background glossiness is ±10 or less and the standard deviation of glossiness is 10 or less, exhibiting excellent gloss uniformity;

B: the difference between glossiness average and white background glossiness is ±(greater than 10 but not greater than 15) and the standard deviation of glossiness is greater than 10 but not greater than 15, posing no problem in gloss uniformity;

C: the difference between glossiness average and white background glossiness is ±(greater than 15 but not greater than 20) and the standard deviation of glossiness is greater than 15 but not greater than 20, exhibiting practical limit; and

D: the difference between glossiness average and white background glossiness exceeds ±20, or the standard deviation of glossiness exceeds 20, disenabling practical use.

### Evaluation Of Ink Absorptivity

The printed surface of each of the above records was visually inspected and evaluated on the following evaluation criteria.

### Evaluation Criteria

A: neither ink bleeding nor flooding, ensuring use without problem;

B: slight ink bleeding, but no problem in practical use; and C: Extensive ink bleeding and flooding, disenabling use.

### Evaluation Of Dot Roundness

With respect to the printed surface of each of the above records, C, M, Y and Bk four color intermediate gradation zones were observed through an optical microscope, and evaluated on the following evaluation criteria.

### Evaluation Criteria

A: excellent in dot roundness, and

B: failure in dot roundness.

### Evaluation Of Water Resistance

Each of the above records was allowed to stand still in an atmosphere of 25° C. and 50% relative humidity for 24 hr, and 0.3 cc of water drop was placed on each of the C, M, Y and Bk patch 100% portions thereof. Further, the records were allowed to stand still in an atmosphere of 25° C. and 50% relative humidity for 24 hr. Thereafter, with respect to these records, the degree of ink bleeding was visually inspected and evaluated on the following evaluation criteria.

### Evaluation Criteria

A: no bleeding observed at all, exhibiting excellent water resistance;

B: bleeding of two colors among the C, M, Y and Bk observed, exhibiting practical limit; and

C: bleeding of three or more colors among the C, M, Y and Bk observed, disenabling practical use.

### Evaluation Of Light Fastness

The above records were subjected to 45 kJ/m² light exposure performed by means of xenon weatherometer Ci35A (manufactured by ATLAS) under such conditions that the 340 nm radiation energy was 0.25 W/m², the black panel temperature 63° C. and the relative humidity 50%. With respect to the image background portion of each of the records after the light exposure, the color difference (average with respect to C, M and Y three colors and image background portion) from that before the light exposure was measured by means of a color difference meter, and evaluated on the following evaluation criteria.

### Evaluation Criteria

A: the color difference is less than 3, ensuring very good light fastness;

B: the color difference is 3 to less than 5, ensuring good light fastness;

C: the color difference is 5 to less than 10, exhibiting practical limit; and

D: the color difference is 10 or greater, disenabling practical use.

TABLE 4

| | White background | | | | | |
|---|---|---|---|---|---|---|
| | glossiness | Gloss uniformity | Ink absorptivity | Dot roundness | Water resistance | Light fastness |
| Example 1A | 28 | A | A | A | A | A |
| Example 2A | 22 | A | A | A | A | A |
| Example 3A | 20 | A | A | A | A | A |
| Comp. Ex. 1A | 2 | D | A | B | A | C |
| Comp. Ex. 2A | 22 | NG | C | NG | NG | NG |

NG: serious ink bleeding and flooding and immeasurable

As apparent from Table 4, while the samples of Examples 1A to 3A are graded as A in all the evaluations of white background glossiness, gloss uniformity, ink absorptivity, dot roundness, water resistance and light fastness, the samples of Comparative Example 1A (absence of porous ink receptive layer) and Comparative Example 2A (copolymer particles other than those of the present invention used as the copolymer particles for constituting the porous ink receptive layer) are graded as B or below among the above evaluations.

### Example 1B

### Production Of Ink Jet Recording Medium

120 parts of inorganic particles (100 parts of silica gel X37B produced by Tokuyama Corporation plus 20 parts of colloidal silica YL produced by Nissan Chemical Industries, Ltd.) and 20 parts of binder resin (PVA R1130 produced by Kuraray Co., Ltd.) were added to water and dispersed, thereby obtaining a coating composition for ink receptive layer whose solid content was 17%. A support (trade name “SA Kinfuji N”, produced by Oji Paper Co., Ltd., basis weight 157 g/m²) on its both sides was coated with this coating composition for ink receptive layer so that the coating amount after drying was 25 g/m², and dried at 120° C. by an air dryer system. Thus, an ink receptive layer was superimposed on the support. Thereafter, the resultant ink receptive layers were coated with the above coating composition 1A for porous ink receptive layer so that the coating amount after drying was 15 g/m², and dried at 90° C. by an air dryer system. Thus, a coating layer was superimposed on each of the ink receptive layers. Thereafter, the coating layers were subjected to hot calendering by means of calendering machine (“bench calendering machine, single plate type” manufactured by Yuri Roll) performed under such conditions that the heating temperature was 95° C., the linear pressure 100 kN/m and the processing speed 2 m/min, thereby forming porous ink receptive layers on the two sides of the support. The thus obtained ink jet recording medium is referred to as sample of Example 1B.

### Example 2B

An ink jet recording medium was produced in the same manner as in Example 1B except that the coating composition 2A for porous ink receptive layer mentioned hereinbefore was employed in place of the coating composition 1A for porous ink receptive layer. The thus obtained ink jet recording medium is referred to as sample of Example 2B.

### Example 3B

An ink jet recording medium was produced in the same manner as in Example 1B except that the coating composition 3A for porous ink receptive layer mentioned hereinbefore was employed in place of the coating composition 1A for porous ink receptive layer. The thus obtained ink jet recording medium is referred to as sample of Example 3B.

### Comparative Example 1B

An ink jet recording medium was produced in the same manner as in Example 1B except that any porous ink receptive layer was not provided at all. The thus obtained ink jet recording medium is referred to as sample of Comparative Example 1B.

### Comparative Example 2B

An ink jet recording medium was produced in the same manner as in Example 1B except that the coating composition 4A for porous ink receptive layer mentioned hereinbefore was employed in place of the coating composition 1A for porous ink receptive layer. The thus obtained ink jet recording medium is referred to as sample of Comparative Example 2B.

### Test Example B

With respect to the obtained ink jet recording mediums and records prepared therefrom in the following manner, the white background glossiness, gloss uniformity, ink absorptivity, dot roundness, water resistance and light fastness were evaluated in the following manner. The evaluation results are listed in Table 5 below.

### Measurement Of White Background Glossiness

With respect to both the coating surfaces of each of the ink jet recording mediums, the 20° specular surface glossiness (according to JIS P8142) was measured by means of deformation glossmeter (model GM-3D manufactured by Murakami Color Research Laboratory), and an average thereof was calculated. The greater this value, the greater the excellence in glossiness.

### Evaluation Of Gloss Uniformity

100% color patches of C, M, Y and Bk four colors were printed on both the coating surfaces of each of the ink jet recording mediums by means of pigment-ink-compliant ink jet printer (trade name “MC2000” manufactured by Seiko Epson Corporation), thereby obtaining records.

With respect to arbitrary 10 points of both the printed surfaces of each of the thus obtained records, the 20° specular surface glossiness of each thereof was measured by means of deformation glossmeter (model GM-3D manufactured by Murakami Color Research Laboratory). Evaluation was conducted from the average and standard deviation of measurements and the above white background glossiness on the following evaluation criteria.

### Evaluation Criteria

A: the difference between glossiness average and white background glossiness is ±10 or less and the standard deviation of glossiness is 10 or less, exhibiting excellent gloss uniformity;

B: the difference between glossiness average and white background glossiness is ±(greater than 10 but not greater than 15) and the standard deviation of glossiness is greater than 10 but not greater than 15, posing no problem in gloss uniformity;

C: the difference between glossiness average and white background glossiness is ±(greater than 15 but not greater than 20) and the standard deviation of glossiness is greater than 15 but not greater than 20, exhibiting practical limit; and

D: the difference between glossiness average and white background glossiness exceeds ±20, or the standard deviation of glossiness exceeds 20, disenabling practical use.

### Evaluation Of Ink Absorptivity

Both the printed surfaces of each of the above records were visually inspected and evaluated on the following evaluation criteria.

### Evaluation Criteria

A: neither ink bleeding nor flooding, ensuring use without problem;

B: slight ink bleeding, but no problem in practical use; and

C: Extensive ink bleeding and flooding, disenabling use.

### Evaluation Of Dot Roundness

With respect to both the printed surfaces of each of the above records, C, M, Y and Bk four color intermediate gradation zones were observed through an optical microscope, and evaluated on the following evaluation criteria.

### Evaluation Criteria

A: excellent in dot roundness, and

B: failure in dot roundness.

### Evaluation Of Water Resistance

Each of the above records was allowed to stand still in an atmosphere of 25° C. and 50% relative humidity for 24 hr, and 0.3 cc of water drop was placed on each of the C, M, Y and Bk patch 100% portions thereof. Further, the records were allowed to stand still in an atmosphere of 25° C. and 50% relative humidity for 24 hr. Thereafter, with respect to these records, the degree of ink bleeding on both the printed surfaces was visually inspected and evaluated on the following evaluation criteria.

### Evaluation Criteria

A: no bleeding observed at all, exhibiting excellent water resistance;

B: bleeding of two colors among the C, M, Y and Bk observed, exhibiting practical limit; and

C: bleeding of three or more colors among the C, M, Y and Bk observed, disenabling practical use.

### Evaluation Of Light Fastness

The above records were subjected to 45 kJ/m² light exposure performed by means of xenon weatherometer Ci35A (manufactured by ATLAS) under such conditions that the 340 nm radiation energy was 0.25 W/m2, the black panel temperature 63° C. and the relative humidity 50%. With respect to the image background portions of both the printed surfaces of each of the records after the light exposure, the color differences (averages with respect to C, M and Y three colors and image background portion) on both the printed surfaces from those before the light exposure were measured by means of a color difference meter, and evaluated on the following evaluation criteria.

### Evaluation Criteria

A: the color difference is less than 3, ensuring very good light fastness;

B: the color difference is 3 to less than 5, ensuring good light fastness;

C: the color difference is 5 to less than 10, exhibiting practical limit; and

D: the color difference is 10 or greater, disenabling practical use.

TABLE 5

| | White background | | | | | |
|---|---|---|---|---|---|---|
| | glossiness | Gloss uniformity | Ink absorptivity | Dot roundness | Water resistance | Light fastness |
| Example 1B | 28 | A | A | A | A | A |
| Example 2B | 22 | A | A | A | A | A |
| Example 3B | 20 | A | A | A | A | A |
| Comp. Ex. 1B | 2 | D | A | B | A | C |
| Comp. Ex. 2B | 22 | NG | C | NG | NG | NG |

NG: serious ink bleeding and flooding and immeasurable

As apparent from Table 5, while the samples of Examples 1B to 3B are graded as A in all the evaluations of white background glossiness, gloss uniformity, ink absorptivity, dot roundness, water resistance and light fastness, the samples of Comparative Example 1B (absence of porous ink receptive layer) and Comparative Example 2B (copolymer particles other than those of the present invention used as the copolymer particles for constituting the porous ink receptive layer) are graded as B or below among the above evaluations.

1. An ink jet recording medium for pigment ink, comprising a support and, superimposed thereon, at least one ink receptive layer, characterized in that at least one of the at least one ink receptive layer is a layer composed of particles of a copolymer of 80° C. or higher glass transition temperature prepared from styrene and/or methyl methacrylate (A) and another copolymerizable monomer (B), the particles having a weight average particle diameter of 50 to 500 nm.

2. The ink jet recording medium for pigment ink as claimed in claim 1, characterized in that the layer composed of copolymer particles constitutes an outermost surface layer.

3. The ink jet recording medium for pigment ink as claimed in claim 2, characterized in that two or more ink receptive layers are provided therein and that a layer adjacent to the outermost surface layer of the ink receptive layers is a layer composed mainly of porous inorganic particles.

4. The ink jet recording medium for pigment ink as claimed in claim 2 or 3, characterized in that the outermost surface layer is one having been glossed by cast coating or calendering.

5. An ink jet recording medium for pigment ink, comprising a support and, superimposed thereon, an ink receptive layer containing inorganic particles,
the ink receptive layer overlaid with a porous ink receptive layer comprising copolymer particles and a cationic coagulant wherein infinitude of copolymer particles are fusion bonded to each other so as to provide interparticulate voids,
the copolymer particles composed of a copolymer of 80° C. or higher glass transition temperature prepared from styrene and/or methyl methacrylate (A) and another monomer copolymerizable with the styrene and/or the methyl methacrylate (B), the particles having a weight average particle diameter of 50 to 500 nm.

6. An ink jet recording medium for pigment ink, comprising a support and, superimposed on each of both major surfaces thereof, an ink receptive layer containing inorganic particles,
at least one of the ink receptive layers overlaid with a porous ink receptive layer comprising copolymer particles and a cationic coagulant wherein infinitude of copolymer particles are fusion bonded to each other so as to provide interparticulate voids,
the copolymer particles composed of a copolymer of 80° C. or higher glass transition temperature prepared from styrene and/or methyl methacrylate (A) and another monomer copolymerizable with the styrene and/or the methyl methacrylate (B), the particles having a weight average particle diameter of 50 to 500 nm.

7. The ink jet recording medium for pigment ink as claimed in claim 5 or 6, wherein the copolymer particles are contained in the porous ink receptive layer in an amount of 70 to 99% by weight.

8. The ink jet recording medium for pigment ink as claimed in claim 5 or 6, wherein the cationic coagulant is a polyamide-polyamine and/or an epichlorhydrin modification product thereof.

9. The ink jet recording medium for pigment ink as claimed in claim 5 or 6, wherein the cationic coagulant is contained in the porous ink receptive layer in an amount of 0.01 to 10% by weight.

10. The ink jet recording medium for pigment ink as claimed in claim 5 or 6, wherein the porous ink receptive layer is one obtained by coating the ink receptive layer with a coating composition comprising the copolymer particles and the cationic coagulant so as to form a coating layer, drying the coating layer and performing hot calendering thereof.

11. The ink jet recording medium for pigment ink as claimed in claim 1, 5 or 6, characterized in that the copolymer particles have a particle diameter distribution, in terms of ratio of weight average particle diameter Dw to number average particle diameter Dn (Dw/Dn), of 1.0 to 2.0.

12. A process for producing an ink jet recording medium for pigment ink, characterized in that a support or another support furnished with an ink receptive layer on its ink receptive layer side is coated with a coating liquid containing particles of a copolymer of 80° C. or higher glass transition temperature prepared from styrene and/or methyl methacrylate (A) and another copolymerizable monomer (B), the particles having a weight average particle diameter of 50 to 500 nm, and thereafter the coating surface in wet or dry form is pressed against a specular roll so as to smooth the coating surface.

13. A process for producing an ink jet recording medium for pigment ink, comprising the steps of:
coating a support with a coating composition containing inorganic particles and drying the resultant coating layer to thereby form an ink receptive layer; and
coating the ink receptive layer with a coating composition containing particles of a copolymer of 80° C. or higher glass transition temperature prepared from styrene and/or methyl methacrylate (A) and another copolymerizable monomer (B), the particles having a weight average particle diameter of 50 to 500 nm, and further containing a cationic coagulant so as to form a coating layer and subjecting the coating layer to drying and hot calendering so as to form a porous ink receptive layer.

14. record comprising the ink jet recording medium for pigment ink as claimed in claim 1, 5 or 6 having characters and/or images recorded thereon with a pigment ink.
